(19) United States
(12) Patent Application Publication
(10) Pub. No.: US 2019/0130226 A1
(43) Pub. Date: May 2, 2019

(54) FACILITATING AUTOMATIC HANDLING OF INCOMPLETE DATA IN A RANDOM FOREST MODEL

(71) Applicant: International Business Machines Corporation, Armonk, NY (US)

(72) Inventors: Shi Jing Guo, Beijing (CN); Xiang Li, Beijing (CN); Hai Feng Liu, Beijing (CN); Jing Mei, Beijing (CN); Zhi Qiao, Beijing (CN); Guo Tong Xie, Xi Er Qi (CN); Shi Wan Zhao, Beijing (CN)

(21) Appl. No.: 15/796,251

(22) Filed: Oct. 27, 2017

(51) Int. Cl. G06K 9/62; G06N 7/00; G06F 17/30

(52) U.S. Cl. CPC G06K 9/6298; G06F 17/30536; G06N 7/005; G06K 9/626

(57) ABSTRACT

Techniques are provided for training and/or executing, by a system operatively coupled to a processor, a modified random forest model using a process that employs significance of data fields in performing imputation, filtering data records out of sample datasets for generating subtrees, and filtering out subtrees for making predictions.

### BACKGROUND

The subject disclosure relates generally to automatically handling incomplete data during training and runtime of a random forest model.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. One or more embodiments described herein include a system, computer-implemented method, and/or computer program product that facilitate automatic handling of incomplete data in a random forest model.

According to an embodiment, a system is provided. The system comprises a memory that stores computer executable components; and a processor that executes the computer executable components stored in the memory. The computer executable components can comprise: a significance component that: determines whether data fields of a dataset are respectively significant based on a significance function, labels data fields that are determined to be significant with an indication of being a significant data field, and labels data fields that are determined not to be significant with an indication of being a non-significant data field; and a training component that trains a modified random forest model based on a training process that employs the indication of being a significant data field and the indication of being a non-significant data field.

In another embodiment, a computer-implemented method is provided. The computer-implemented method can include determining, by a system operatively coupled to a processor, whether data fields of a dataset are respectively significant based on a significance function, labeling, by the system, data fields that are determined to be significant with an indication of being a significant data field, and labeling, by the system, data fields that are determined not to be significant with an indication of being a non-significant data field; and training, by the system, a modified random forest model based on a training process that employs the indication of being a significant data field and the indication of being a non-significant data field.

In another embodiment, a computer program product for training a modified random forest model is provided. The computer program product can include a computer readable storage medium having program instructions embodied therewith. The program instructions can be executable by a processer to cause the processer to: determine whether data fields of a dataset are respectively significant based on a significance function, label data fields that are determined to be significant with an indication of being a significant data field, and label data fields that are determined not to be significant with an indication of being a non-significant data field; and train a modified random forest model based on a training process that employs the indication of being a significant data field and the indication of being a non-significant data field

### BRIEF DESCRIPTION OF THE DRAWINGS

FIG. 1 illustrates a block diagram of an example, non-limiting system in accordance with one or more embodiments described herein.

FIG. 2 illustrates a block diagram of an example, non-limiting modified random forest component in accordance with one or more embodiments described herein.

FIG. 3 illustrates a block diagram of an example, non-limiting runtime component in accordance with one or more embodiments described herein.

FIG. 4 illustrates a block diagram of an example, non-limiting training of a modified random forest model in accordance with one or more embodiments described herein.

FIG. 5 illustrates a block diagram of an example, non-limiting data record in accordance with one or more embodiments described herein.

FIG. 6 illustrates a block diagram of an example, non-limiting imputation operation in accordance with one or more embodiments described herein.

FIG. 7 illustrates a block diagram of an example, non-limiting filtering operation in accordance with one or more embodiments described herein.

FIG. 8 illustrates a block diagram of an example, non-limiting runtime analysis of a new data record using a modified random forest model in accordance with one or more embodiments described herein.

FIG. 9 illustrates a block diagram of an example, non-limiting imputation operation on a new data record in accordance with one or more embodiments described herein.

FIG. 10 illustrates a block diagram of an example, non-limiting subtree selection operation for a new data record in accordance with one or more embodiments described herein.

FIG. 11 illustrates a flow diagram of another exemplary, non-limiting computer-implemented method in accordance with one or more embodiments described herein.

FIG. 12 illustrates a flow diagram of a further example, non-limiting computer-implemented method in accordance with one or more embodiments described herein.

FIG. 13 illustrates a block diagram of an example, non-limiting operating environment in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however in various cases, that the one or more embodiments can be practiced without these specific details.

A random forest model is a common mechanism employed to perform analysis (e g mining, learning, modeling, predicting, or any other suitable form of data analysis) of large datasets. For example, in performing clinical studies, electronic health record (HER) for a large set of patients can be analyzed to learn relationships between medical conditions and attributes patients in the EHRs. Oftentimes, data records are incomplete. For example, an EHR for a patient can be missing some data values for data fields of the EHR, such as for tests that were not performed, or incomplete patient history, or missing some medical conditions, or any other missing data values. Missing data values can cause a severe degradation in the performance (e.g. accuracy of analysis) of a random forest model. This is especially noted in use for clinical studies. In some cases, imputation (e.g. average value, median value, most common value, or any other suitable imputation mechanism) is employed to fill in the missing data values when using random forest models. It is to be appreciated that while embodiments describe herein employ clinical studies for exemplary purposes only, any suitable type of data can analyzed using improved random forest model techniques described herein.

Some of the challenges with training random forest models and runtime of random forest models are how to handle missing data value, how to fill in missing data values, and how to use missing data values.

To address the challenges in handling missing data values in a random forest model as described herein, one or more embodiments of the invention can employ techniques to factor the significance of the data fields in which data values are missing to automatically analyze datasets using a random forest model. For example, the fact that a data field is missing or contains a data value in itself can provide useful information. In essence, the fact that a data value is missing for a data field is not random, but can have significance. For example, a data field for blood glucose level can be tied to diabetes. The fact that an EHR has a data value for the data field for blood glucose level can infer that a patient can have a diabetic condition, whereas the fact that the data field does not have a data value can infer that the patient does not have a diabetic condition. In another example, a data field for an electrocardiogram (ECG) can inform as to whether a patient has a heart condition. The modified random forest model techniques described in embodiments herein can determine which data fields of a data record are significant and which data fields are not significant and take specific actions during training and runtime with respect to a random forest model based on the data fields being significant or not significant. For example, the modified random forest model techniques, during training and runtime, can skip performing imputation for significant data fields that are missing data values. In another example, the modified random forest model techniques, during training, can filter out data records in sample datasets that are missing data values for significant data fields that are sampled in a sample dataset. In a further example, the modified random forest model techniques, during runtime, can select subtrees of the random forest tree that have all their sampled data fields corresponding to data fields that have data values of a new data record being analyzed.

One or more embodiments of the subject disclosure is directed to computer processing systems, computer-implemented methods, apparatus and/or computer program products that facilitate efficiently, effectively, and automatically (e.g., without direct human involvement) analyzing datasets using modified random forest models. The computer processing systems, computer-implemented methods, apparatus and/or computer program products can employ hardware and/or software to solve problems that are highly technical in nature (e.g., adapted to generate and/or employ one or more different detailed, specific and highly-complex modified random forest models that can automatically analyze datasets) that are not abstract and that cannot be performed as a set of mental acts by a human. For example, a human, or even thousands of humans, cannot efficiently, accurately and effectively manually gather and analyze thousands of data records related to a variety of observations in a real-time network based computing environment to analyze datasets. One or more embodiments of the subject computer processing systems, methods, apparatuses and/or computer program products can enable the automated analysis of datasets using modified random forest models in a highly accurate and efficient manner to achieve one or more goals. By employing a modified random forest model, the processing time and/or accuracy associated with the automated dataset analysis is substantially improved. Additionally, the nature of the problem solved is inherently related to technological advancements in automated datasets analysis that have not been previously addressed in this manner. Further, one or more embodiments of the subject modified random forest model techniques can facilitate improved performance of automated datasets analysis that provides for more efficient usage of storage resources, processing resources, and network bandwidth resources to provide highly granular and accurate automated datasets analysis. For example, by reducing the number of data fields for which imputation is performed, reducing the number of datasets in the random sampling through the filtering out of data records, and being selective in the subtrees used for prediction, efficiency and effectiveness is improved, and wasted usage of processing, storage, and network bandwidth resources can be avoided by decreasing the amount of data being stored and processed while also provided a more accurate analysis result (e.g. prediction, decision, or any other suitable result of the analysis). This provides a clear technical improvement to the operation of a computing device on which a random forest model is trained and/or executed.

By way of overview, aspects of systems, apparatuses, or processes in accordance with the present invention can be implemented as machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

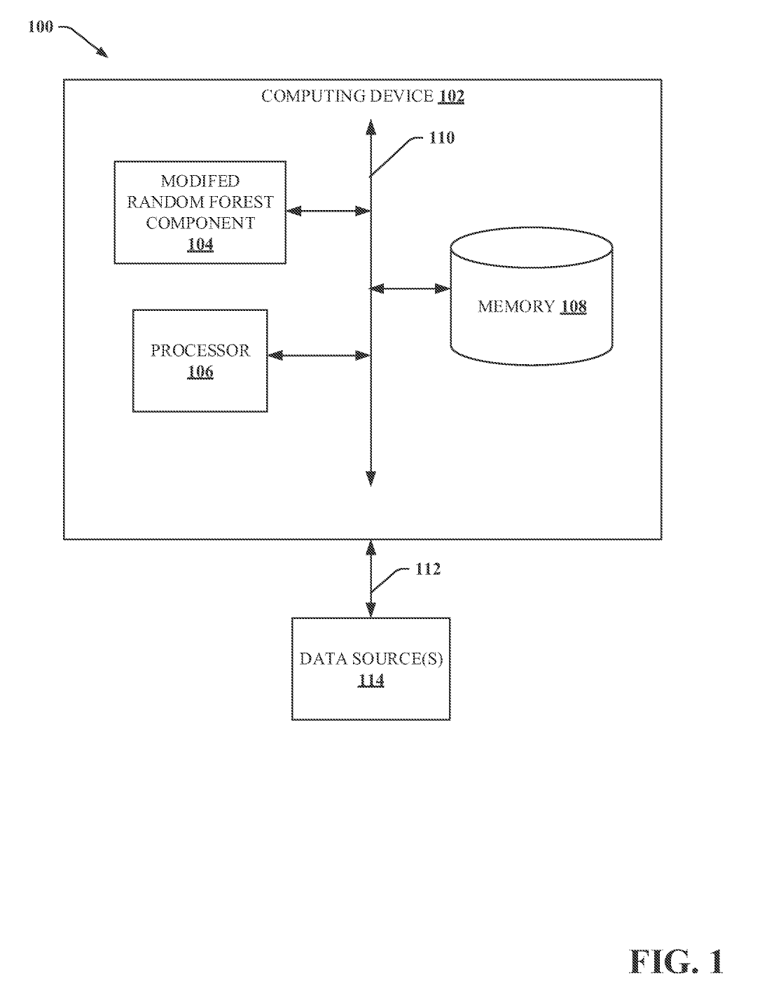

FIG. 1 illustrates a block diagram of an example, non-limiting system 100 that facilitates automatically analyzing one or more datasets using a modified random forest model in accordance with one or more embodiments described herein. Repetitive description of like elements employed in one or more embodiments described herein is omitted for sake of brevity.

System 100 can include a computing device 102, one or more networks 112, and one or more data sources 114. Computing device 102 can include a modified random forest component 104 that can facilitate automatically analyzing one or more datasets using a modified random forest model as discussed in more detail below.

Computing device 102 can also include or otherwise be associated with at least one included (or operatively coupled to) memory 108 that can store computer executable components (e.g., computer executable components can include, but are not limited to, the modified random forest component 104 and associated components), and can store any data generated by modified random forest component 104 and associated components. Computing device 102 can also include or otherwise be associated with at least one processor 106 that executes the computer executable components stored in memory 108. Computing device 102 can further include a system bus 110 that can couple the various server components including, but not limited to, the modified random forest component 104, memory 108 and/or processor 106.

Computing device 102 can be any computing device that can be communicatively coupled to one or more data sources 114, non-limiting examples of which can include, but are not limited to, include a wearable device or a non-wearable device Wearable device can include, for example, heads-up display glasses, a monocle, eyeglasses, contact lens, sunglasses, a headset, a visor, a cap, a mask, a headband, clothing, or any other suitable device that can be worn by a human or non-human user. Non-wearable devices can include, for example, a mobile device, a mobile phone, a camera, a camcorder, a video camera, laptop computer, tablet device, desktop computer, server system, cable set top box, satellite set top box, cable modem, television set, monitor, media extender device, blu-ray device, digital versatile disc or digital video disc (DVD) device, compact disc device, video game system, portable video game console, audio/video receiver, radio device, portable music player, navigation system, car stereo, a mainframe computer, a robotic device, a wearable computer, an artificial intelligence system, a network storage device, a communication device, a web server device, a network switching device, a network routing device, a gateway device, a network hub device, a network bridge device, a control system, or any other suitable computing device 102.

A data source 114 can be any device that can communicate with computing device 102 and that can provide information to computing device 102 or receive information provided by computing device 102. For example, data source 114 can be a hospital server that maintains patient EHRs. Computing device 102 can obtain one or more datasets of patient EHRs from data source 114. It is to be appreciated that computing device 102 and data source 114 can be equipped with communication components (not shown) that enable communication between computing device 102, and data source 114 over one or more networks 112.

The various devices (e.g., computing device 102, and data source 114) and components (e.g., modified random forest component 104, memory 108, processor 106 and/or other components) of system 100 can be connected either directly or via one or more networks 112. Such networks 112 can include wired and wireless networks, including, but not limited to, a cellular network, a wide area network (WAN) (e.g., the Internet), or a local area network (LAN), non-limiting examples of which include cellular, WAN, wireless fidelity (Wi-Fi), Wi-Max, WLAN, radio communication, microwave communication, satellite communication, optical communication, sonic communication, or any other suitable communication technology.

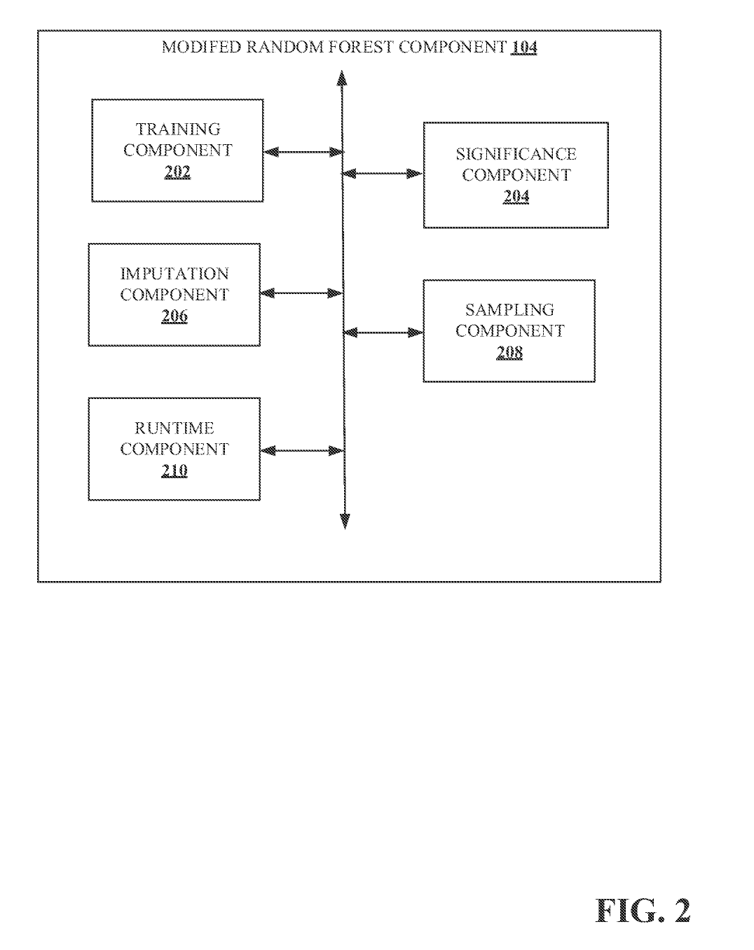

FIG. 2 illustrates a block diagram of an example, non-limiting modified random forest component 104 in accordance with one or more embodiments described herein. Repetitive description of like elements employed in one or more embodiments described herein is omitted for sake of brevity.

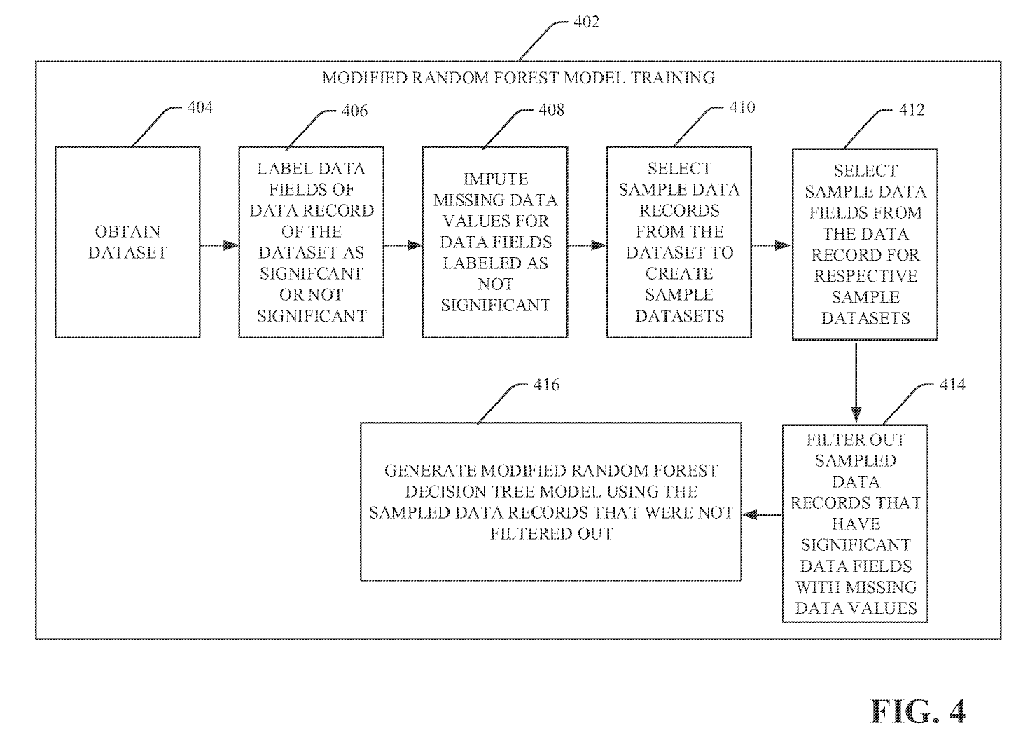

Modified random forest component 104 can include training component 202 that can automatically train a modified random forest model as described in more detail with respect to FIGS. 4, 5, 6, 7, and 11. Modified random forest component 104 can also include significance component 204 that can automatically determine significance of data fields in a data record. Furthermore, modified random forest component 104 can also include imputation component 206 that can automatically impute data values for data fields that are determined to be not significant and missing data values. Additionally, modified random forest component 104 can also include sampling component 208 that can sample data records from a data set for the modified random forest model and filter our data records from the sampling that have missing data values for data field that are determined to be significant. Modified random forest component 104 can also include runtime component 210 that can employ the modified random forest model to analyze a new data record.

Algorithm 1 depicts a non-limiting example algorithm that Modified random forest component 104 can employ for facilitating training a modified random forest model in accordance with one or more embodiments described herein.

Algorithm 1

Precondition: A training set S := (x1; y1); : : : ; (xn; yn), feature set F, and
number of trees B in modified random forest H, where Fs is a significant
feature of feature set F,, Fn is a non-significant feature of feature set F,
Φ is a null set, x1 is a first record feature vector, xn is a n-th record
feature vector, y1 is a first record label. and yn is a n-th record label
1 Function ModifiedRandomForest (S,F)
2 (Fs, Fn) = FindingFeatures(F) /* find significant and non-significant
features */
3 Imputation(S) for Fn /* impute missing values for significant features */
4 H ← Φ /* initialize random forest with null set */
5 For i∈1,...,B do /*iterate for B subtrees*/
6 S(i) Sample cases from S /* sample cases from S */
7 F(i) Sample features from F /* sample features from F */
8 S(i)new=DeleteMissingData(S(i), Fs(i)) /* drop cases with
missing values for sampled features F(i) and generate new sub data set
S(i)new */
9 hᵢ Decision Tree Learn (S(i)new, F(i)) /* learn decision tree hᵢ */
10 H ← hᵢ/* add decision tree hᵢ ro random forest model H*/
11 end for
12 return H
13 end function

FIG. 4 illustrates a block diagram of an example, non-limiting training 402 of a modified random forest model by training component 202 in accordance with one or more embodiments described herein. Repetitive description of like elements employed in one or more embodiments described herein is omitted for sake of brevity.

As indicated at element 404, training component 202 can obtain a dataset for training the modified random forest model. As indicated at element 406, training component 202 can employ significance component 204 to label the data fields of data records of the data set as being significant or not significant.

Significance component 204 can employ any suitable significance function to determine whether a data field is significant or not significant using the dataset. In a non-limiting example, a significance function can employ a Chi-square test and based on a comparison of a p-value of the Chi-square test to a significance criterion determine whether a data field is significant or not significant. For example, a data field having a p-value less than or equal to 0.05 can be determined by significance component 204 to be significant, while a data field having a p-value greater than 0.05 can be determined by significance component 204 to be not significant. It is to be appreciated that any suitable p-value can be employed for determining significance of a data field. Furthermore, it is to be appreciated that a Chi-square test is just one example of a test that can be employed to determine significance of a data field. In a non-limiting example, the chi-squared test can be used to determine whether there is a significant difference between the expected frequencies and the observed frequencies in one or more categories. In this method, for each feature, the expected frequencies can be the label frequencies of the cases which have values for the feature, and the observed frequencies can be the label frequencies of the cases which haven't values for the feature. Chi-squared tests are often constructed from a sum of squared errors, or through the sample variance. In another non-limiting example, P-value can be the probability of observing a sample statistic as close to a test static. The p-value can be the probability that shows the chi-square value greater than the empirical value of the data. It is to be appreciated that any suitable function can be employed by significance component 204 to determine significance of a data field. Significance component 204 can label respective data fields with indications as significant or not significant based on determinations of significance.

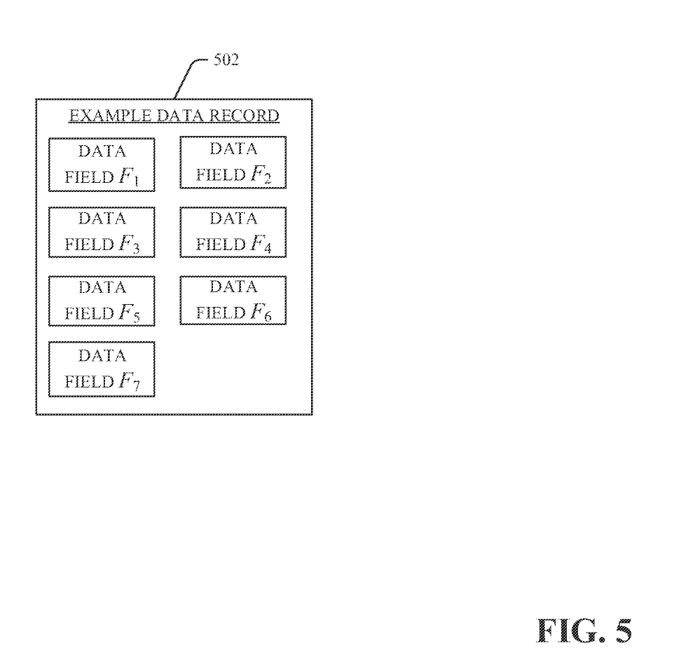

FIG. 5 illustrates a block diagram of an example, non-limiting data record 502 in accordance with one or more embodiments described herein. Repetitive description of like elements employed in one or more embodiments described herein is omitted for sake of brevity. In this non-limiting example, data record 502 has seven data fields F₁, F₂, F₃, F₄, F₅, F₆, and F₇. Significance component 204 can perform a significance function on data fields F₁, F₂, F₃, F₄, F₅, F₆, and F₇ to determine which data fields are significant and which data fields are not significant.

Referring back to FIG. 4, as indicated at element 408, training component 202 can imputation component 206 to impute data values for data fields that are labeled as not significant and are missing data values. It is to be appreciated that data values are not imputed for data fields that are labeled as significant and are missing values. Advantageously, not imputing data values for significant data fields can reduce error that can be introduced if data values are imputed for significant data fields that have missing data values.

Imputation component 206 can employ any suitable imputation function to impute data values for data fields that are labeled as not significant and are missing data values. For example, imputation component 206 can employ an imputation function that can determine an imputed data value for a data field from data records that have data values for the data field, and employ the imputed data value as the data value for one or more data records that are missing data values for the data field. In a non-limiting example, the imputation function can comprise a weighted average function, an average function, a median function, a mean function, a most common value function, a random guess function, a zero-value replacement function, a regression estimation function, a Bayesian function, or any other suitable function to impute a data value.

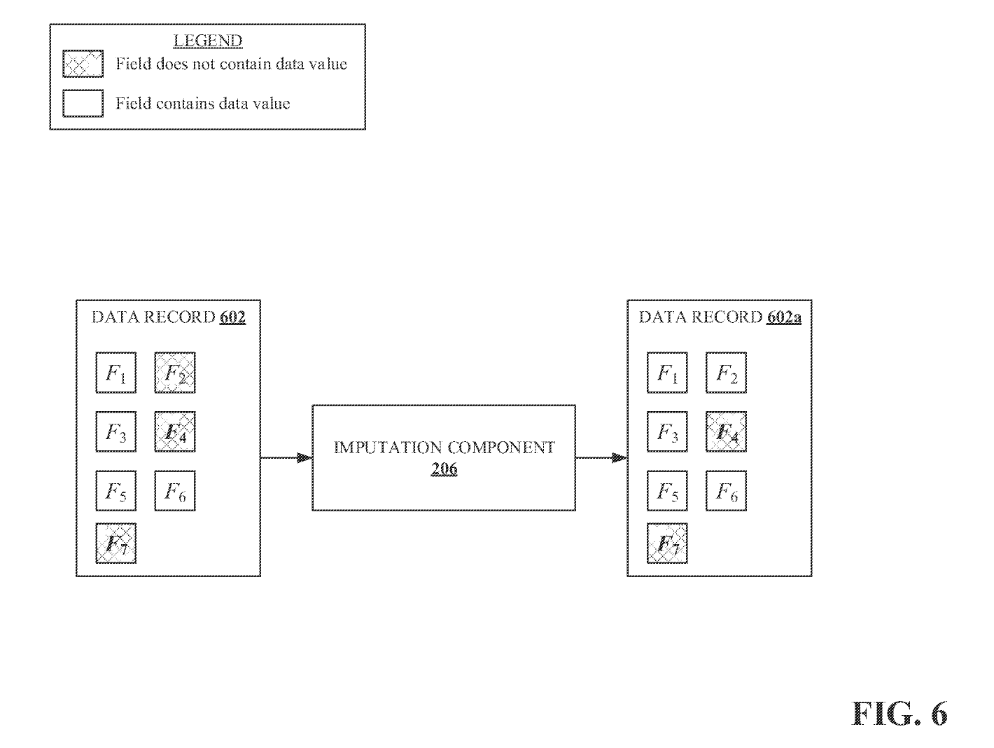

FIG. 6 illustrates a block diagram of an example, non-limiting imputation operation of imputation component 206 in accordance with one or more embodiments described herein. Repetitive description of like elements employed in one or more embodiments described herein is omitted for sake of brevity. In this non-limiting example, imputation component 206 obtains data record 602 which has seven data fields F₁, F₂, F₃, F₄, F₅, F₆, and F₇. In data record 602, data fields F₁, F₂, F₃, F₅, and F₆ are labeled as not significant and data fields F₄ and F₇ are labeled as significant. Also, in data record 602, data fields F₂, F₄, and F₇ do not have data values. Imputation component 206 can impute a data value for data field F₂, and not impute data values for data fields F₄ and F₇ to produce data record 602a.

Referring back to FIG. 4, as indicated at elements 410, 412, and 414, training component 202 can employ sampling component 208 to sample data records from a dataset for to create a sample dataset for the modified random forest model, sample data fields from the sample dataset, and filter out data records from the sample dataset that have missing data values for data fields that are labeled as significant.

Sampling component 208 can employ any suitable sampling function to sample (e.g. select) data records from a dataset to create a sample dataset for use in generating the modified random forest model. For example, sampling component 208 can generate a plurality of sample datasets which are subsets of the dataset. In a non-limiting example, the sampling function can be a random function, a random with replacement function, or any other suitable sampling function for selected sample datasets for a random forest model. For respective sample datasets, sampling component can sample (e.g. select) data fields to be employed for creating a subtree of the modified random forest model. In this manner one or more different sample datasets can employ different data fields for creating respective subtrees of the modified random forest model. Sampling component 208 can filter out data records in the sample datasets that contain data fields that are labeled as significant and are missing data values. The sample datasets would then no longer include data records that contain selected data fields that are labeled as significant and are missing data values. Respective sample datasets can be employed to generate decision trees in the modified random forest model.

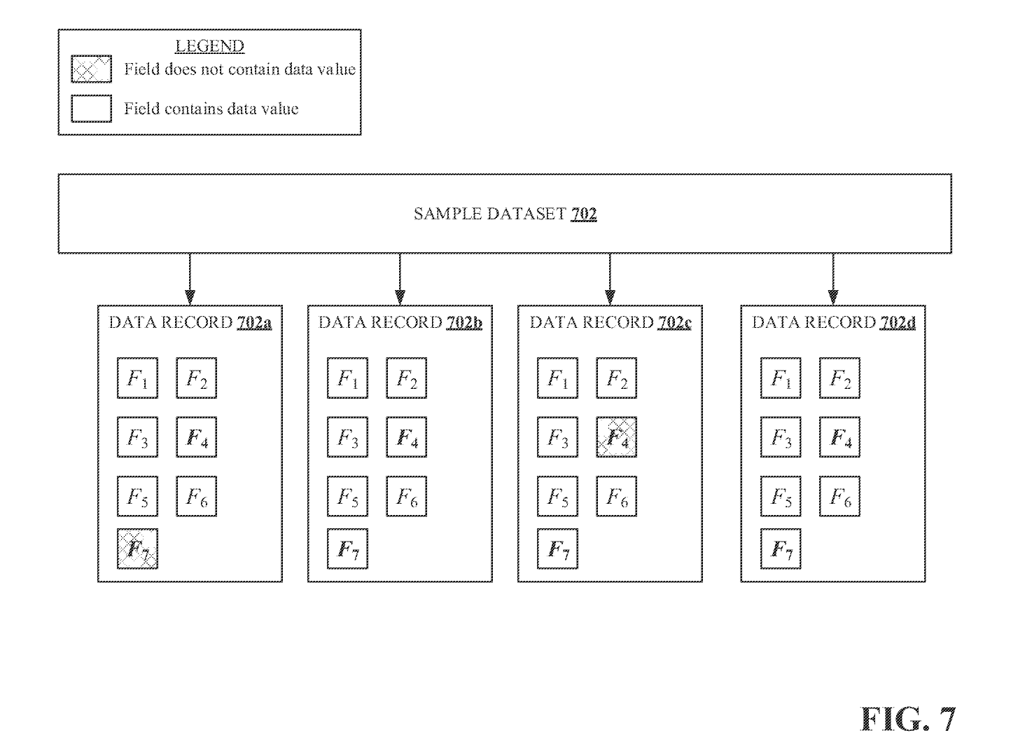

FIG. 7 illustrates a block diagram of an example, non-limiting filtering operation of sampling component 208 in accordance with one or more embodiments described herein. Repetitive description of like elements employed in one or more embodiments described herein is omitted for sake of brevity. In this non-limiting example, sampling component 208 selects sample dataset 702 from a dataset, and sample dataset 702 has four data records 702a, 702b, 702c, and 702d. Continuing with the example from FIG. 6, data fields F₁, F₂, F₃, F₅, and F₆ are labeled as not significant and data fields F₄ and F₇ are labeled as significant, and data fields F₁, F₂, F₃, F₄, and F₅ have been sampled for this sample dataset. In data record 702a, data field F₇ does not have a data value, and thus sampling component 208 can keep data record 702a in sample dataset 702 since data field F₇ is not one of the sample data fields for this sample dataset. In data record 702b, all data fields have values, and thus sampling component 208 can keep data record 702b in sample dataset 702. In data record 702c, data field F₄ does not have a data value, and thus sampling component 208 can discard data record 702c from sample dataset 702 since data field F₄ is one of the sample data fields for this sample dataset. In data record 702d, all data fields have values, and thus sampling component 208 can keep data record 702d in sample dataset 702. Therefore, sample dataset 702 will contain data records 702a, 702b, and 702d after discarding data record 702c. It is to be appreciated that a sample dataset can comprise any suitable number of data records.

Referring back to FIG. 4, as indicated at element 414, training component 202 can employ the sample datasets that have been filtered by sampling component 208 to generate respective decision trees (e.g. subtrees) of the modified random forest model using any suitable decision tree generation function. With the respective decision trees generated, the random forest model can be considered trained.

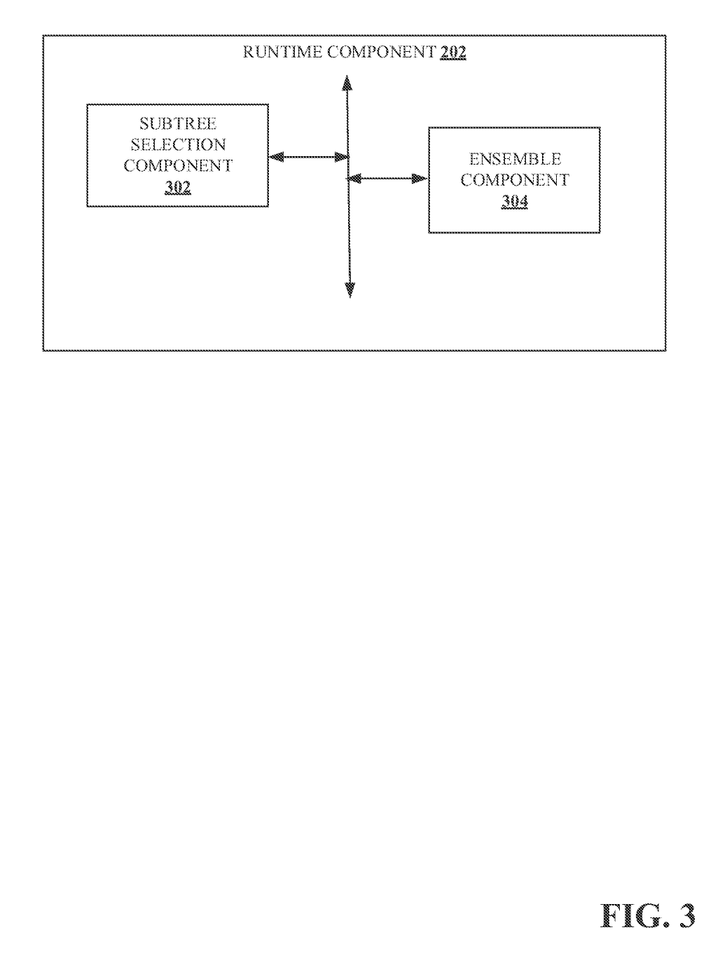

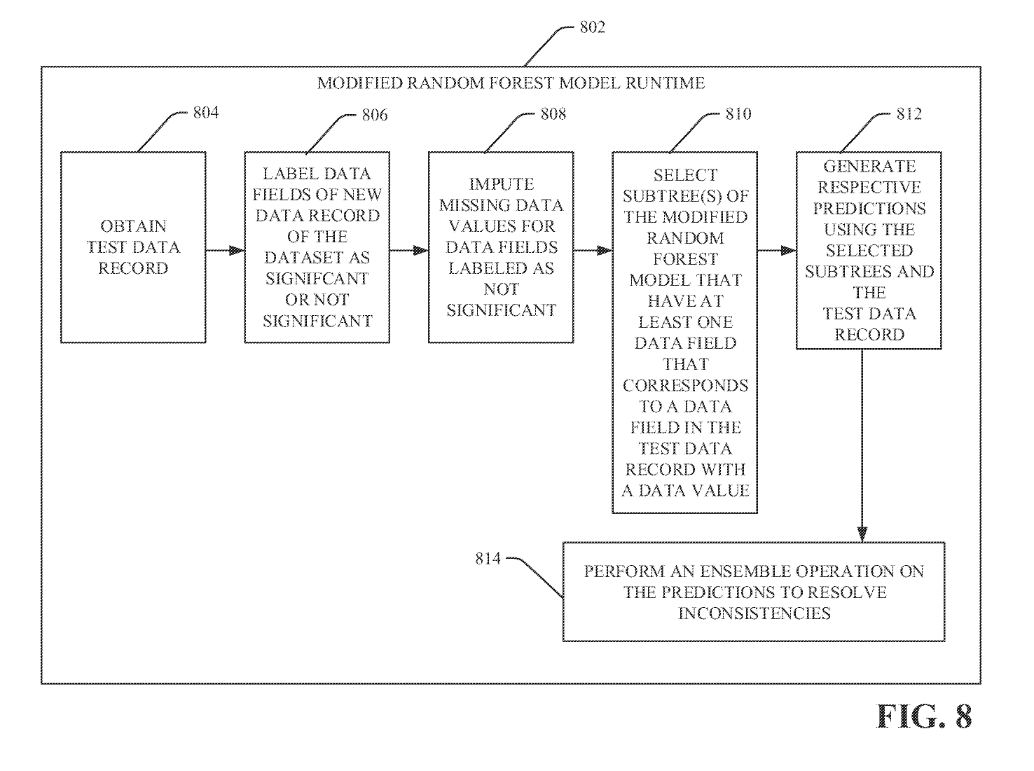

FIG. 3 illustrates a block diagram of an example, non-limiting runtime component 210 in accordance with one or more embodiments described herein. Repetitive description of like elements employed in one or more embodiments described herein is omitted for sake of brevity. Runtime component 210 can employ the modified random forest model to analyze a new data record as described in more detail with respect to FIGS. 8. 9. 10, and 12.

FIG. 8 illustrates a block diagram of an example, non-limiting runtime 802 analysis of a new data record using a modified random forest model by runtime component 210 in accordance with one or more embodiments described herein. Repetitive description of like elements employed in one or more embodiments described herein is omitted for sake of brevity.

As indicated at element 804, runtime component 210 can obtain a new data record for analysis using a modified random forest model. As indicated at element 806, runtime component 210 can call significance component 204 to label the data fields of the new data record as significant or not significant as described above. As indicated at element 808, runtime component 210 can call imputation component 206 to impute data values for data fields of the new data record that are labeled as not significant and are missing data values as described above.

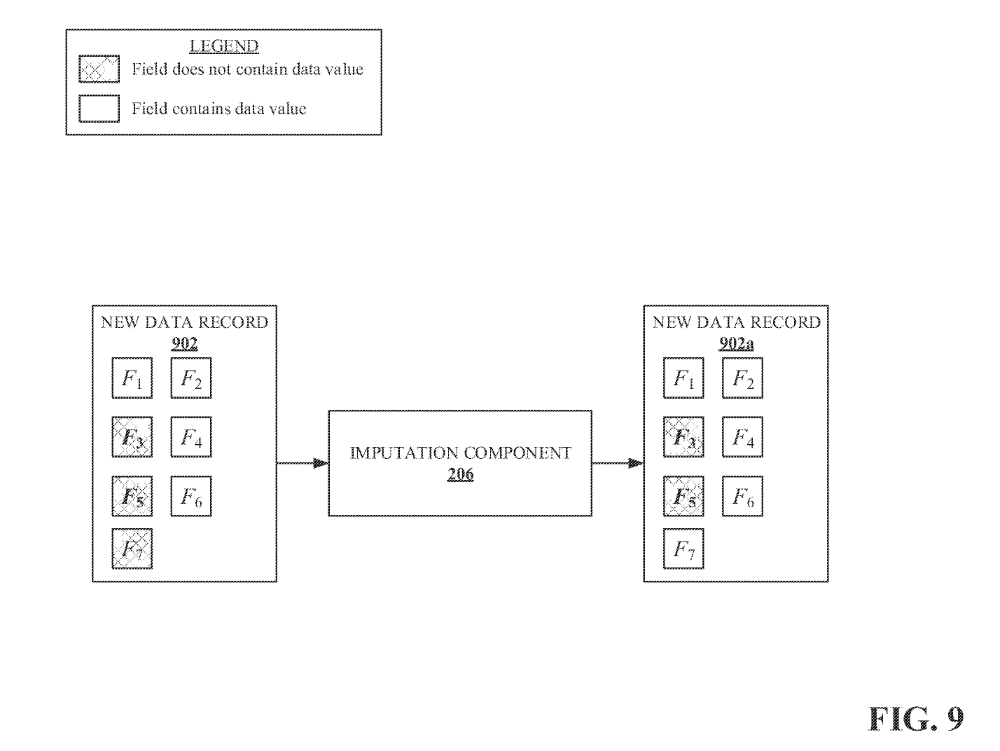

FIG. 9 illustrates a block diagram of an example, non-limiting imputation operation on a new data record by imputation component 206 in accordance with one or more embodiments described herein. Repetitive description of like elements employed in one or more embodiments described herein is omitted for sake of brevity. In this non-limiting example, imputation component 206 obtains new data record 902 which has seven data fields F₁, F₂, F₃, F₄, F₅, F₆, and F₇. In new data record 902, data fields F₁, F₂, F₄, F₆, and F₇ are labeled as not significant and data fields F₃ and F₅ is labeled as significant. Also, in new data record 902, data fields F₃, F₅, and F₇ do not have data values. Imputation component 206 can impute a data value for data field F₇, and not impute data values for data fields F₃ and F₅ to produce new data record 902a.

Referring back to FIG. 3, runtime component 210 can include subtree selection component 302 that selects subtrees for analysis of a new data record. As indicated at element 810 of FIG. 4, subtree selection component 302 can select one or more subtrees of the modified random forest model that have all of their sample data fields that correspond data fields that have data values in the new data record.

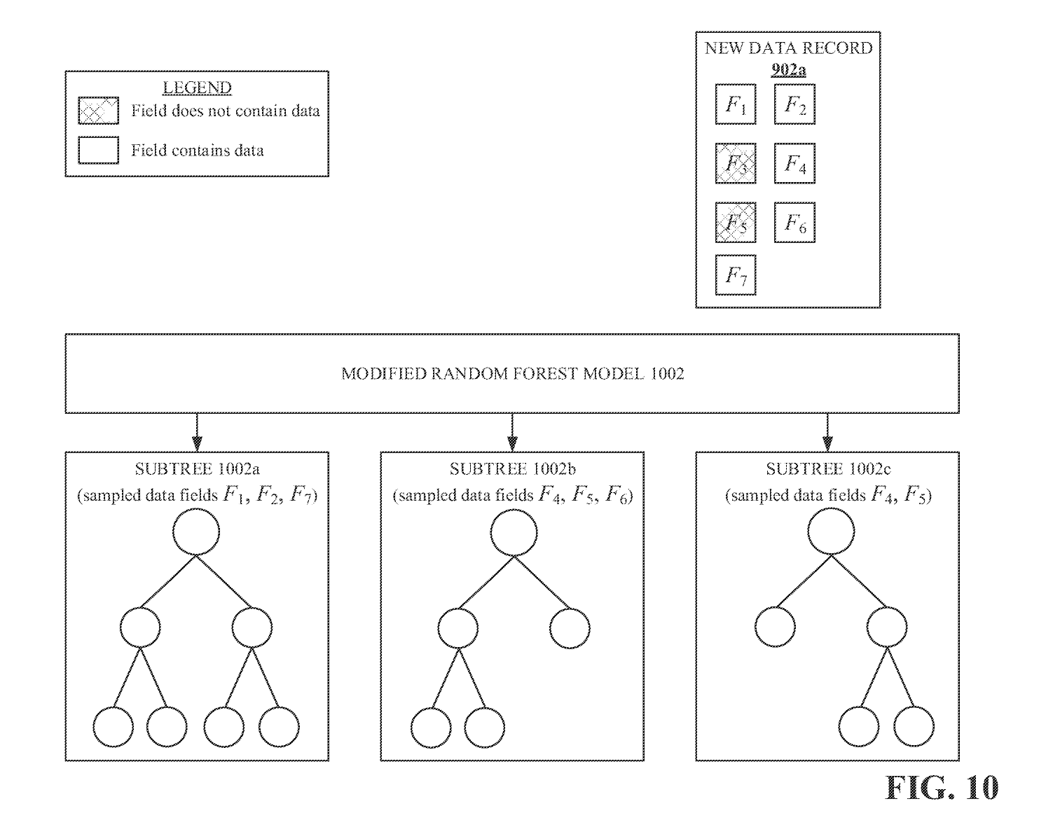

FIG. 10 illustrates a block diagram of an example, non-limiting subtree selection operation for a new data record by subtree selection component 302 in accordance with one or more embodiments described herein. Repetitive description of like elements employed in one or more embodiments described herein is omitted for sake of brevity. Continuing with the example of FIG. 9, subtree selection component 302 can obtain new data record 902a and select one or more subtrees from modified random forest model 1002. In this non-limiting example, subtree 1002a is based on sampled data fields F₁, F₂, and F₇. Subtree selection component 302 can select subtree 1002a because sample data fields F₁, F₂, and F₇ corresponds to data fields F₁, F₂, and F₇ with a data value in new data record 902. Subtree 1002b is based on sampled data fields F₄, F₅, and F₆. Subtree selection component 302 will not select subtree 1002b because sample data field F₅ corresponds to data field F₅ with a missing data value in new data record 902, even though data fields F₄ and F₆ corresponds to data fields F₄ and F₆ with data values in new data record 902. Subtree 1002c is based on sampled data fields F₄ and F₅. Subtree selection component 302 will select subtree 1002c because sample data fields F₄ and F₅ correspond to data fields F₄ and F₅ with data values in new data record 902. Therefore, in this example subtrees 1002a and 1002c are selected for generating respective predictions using new data record 902a.

Referring back to FIG. 8, as indicated at element 812, runtime component 210 can generate respective predictions from the one or more selected subtrees and the new data record. For example, the new data record can be run through a selected subtree to generate a prediction for the new data record. This can be done for all of the selected subtrees to generate respective predictions. Some of the respective predictions from the selected subtrees can differ from each other.

Referring back to FIG. 3, runtime component 210 can include ensemble component 304 that employs an ensemble function to handle the differences in the respective predictions from the selected subtrees and generate a final prediction result. In a non-limiting example, ensemble function can employ bagging to handle the differences in the respective predictions from the selected subtrees and generate a final prediction result. It is to be appreciated that any suitable ensemble function can be employed.

While FIGS. 1, 2, 3, 4, 5, 6, 7, 8, 9, and 10 depict separate components in computing device 102, it is to be appreciated that two or more components can be implemented in a common component. Further, it is to be appreciated that the design of the computing device 102 can include other component selections, component placements, etc., to facilitate automatically analyzing a dataset using a modified random forest model in accordance with one or more embodiments described herein. Moreover, the aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components can be combined into a single component providing aggregate functionality. The components can also interact with one or more other components not specifically described herein for the sake of brevity, but known by those of skill in the art.

Further, some of the processes performed can be performed by specialized computers for carrying out defined tasks related to automatically analyzing datasets using a modified random forest model. The subject computer processing systems, methods apparatuses and/or computer program products can be employed to solve new problems that arise through advancements in technology, computer networks, the Internet and the like. The subject computer processing systems, methods apparatuses and/or computer program products can provide technical improvements to systems automatically analyzing datasets using a modified random forest model in a live environment by improving processing efficiency among processing components in these systems, reducing delay in processing performed by the processing components, and/or improving the accuracy in which the processing systems automatically analyzing datasets using a modified random forest model.

The embodiments of devices described herein can employ artificial intelligence (AI) to facilitate automating one or more features described herein. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system, environment, etc. from a set of observations as captured via events and/or data. Determinations can be employed to identify a specific context or action, or can generate a probability distribution over states, for example. The determinations can be probabilistic—that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, etc.)) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determination.

A classifier can map an input attribute vector, z=(z1, z2, z3, z4, zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence can be employed. Classification as used herein also is inclusive of statistical regression that is utilized to develop models of priority.

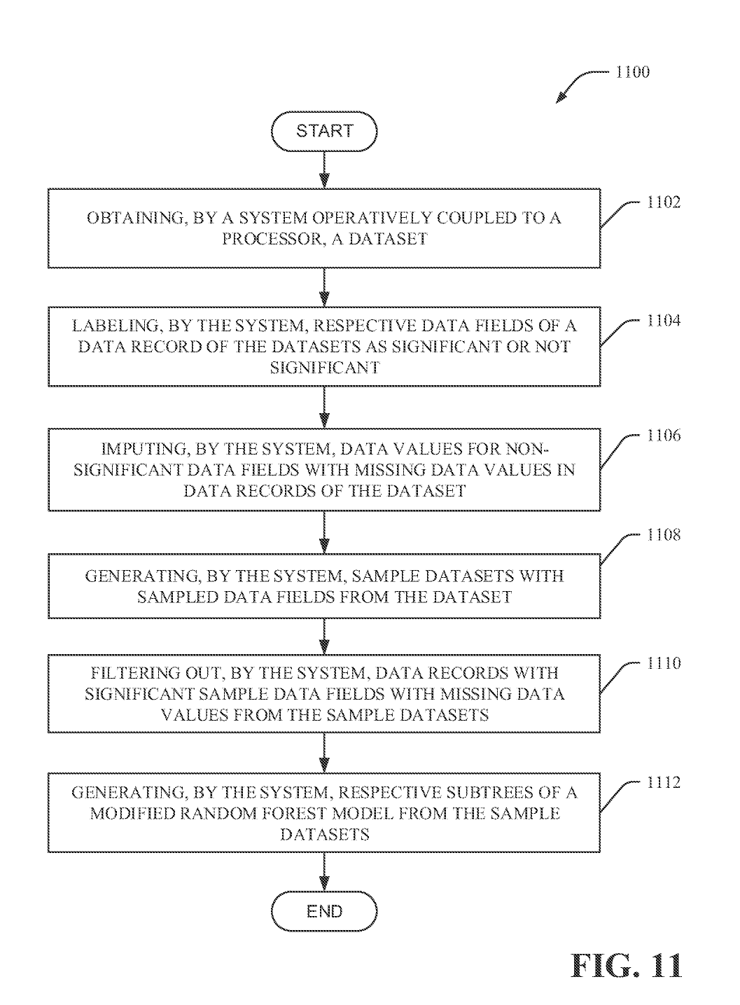

FIG. 11 illustrates a flow diagram of an example, non-limiting computer-implemented method 1100 that facilitates automatically training a modified random forest model is provided in accordance with one or more embodiments described herein. Repetitive description of like elements employed in other embodiments described herein is omitted for sake of brevity.

At 1102, method 1100 can comprise obtaining, by a system operatively coupled to a processor, a dataset (e.g., via a training component 202, a modified random forest component 104, and/or a computing device 102). At 1104, method 1100 can comprise labeling, by the system, respective data fields of a data record of the datasets as significant or not significant (e.g., via a significance component 204, a training component 202, a modified random forest component 104, and/or a computing device 102). At 1106, method 1100 can comprise imputing, by the system, data values for non-significant data fields with missing data values in data records of the dataset (e.g., via an imputation component 206, a training component 202, a modified random forest component 104, and/or a computing device 102). At 1108, method 1100 can comprise generating, by the system, sample datasets with sampled data fields from the dataset (e.g., via a sampling component 208, a training component 202, a modified random forest component 104, and/or a computing device 102). At 1110, method 1100 can comprise filtering out, by the system, data records with significant sample data fields with missing data values from the sample datasets (e.g., via a sampling component 208, a training component 202, a modified random forest component 104, and/or a computing device 102). At 1110, method 1100 can comprise generating, by the system, respective subtrees of a modified random forest model from the sample datasets (e.g., via a training component 202, a modified random forest component 104, and/or a computing device 102).

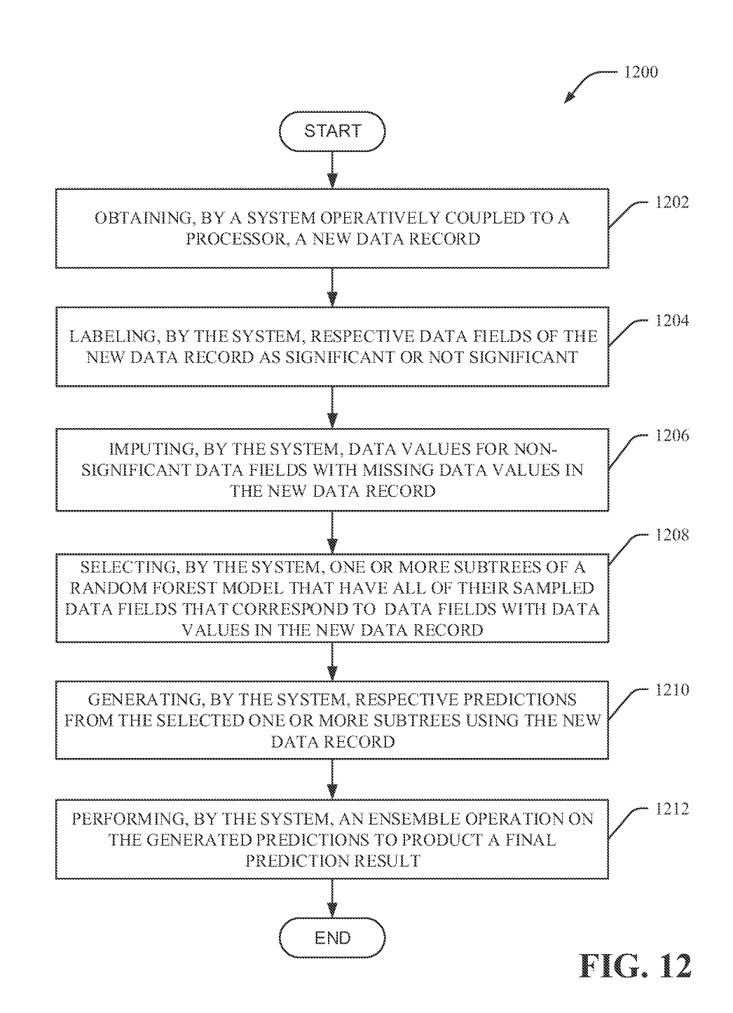

FIG. 12 illustrates a flow diagram of an example, non-limiting computer-implemented method 1200 that facilitates automatically analyzing a new data record using a modified random forest model in accordance with one or more embodiments described herein. Repetitive description of like elements employed in other embodiments described herein is omitted for sake of brevity.

At 1202, method 1200 can comprise obtaining, by a system operatively coupled to a processor, a new data record (e.g., via a runtime component 210, a modified random forest component 104, and/or a computing device 102). At 1204, method 1200 can comprise labeling, by the system, respective data fields of the new data record as significant or not significant (e.g., via a significance component 204, a runtime component 210, a modified random forest component 104, and/or a computing device 102). At 1206, method 1200 can comprise imputing, by the system, data values for non-significant data fields with missing data values in the new data record (e.g., via an imputation component 206, a runtime component 210, a modified random forest component 104, and/or a computing device 102). At 1208, method 1200 can comprise selecting, by the system, one or more subtrees of a random forest model that have all of their sampled data fields that correspond to data fields with data values in the new data record (e.g., via a subtree selection component 302, a runtime component 210, a modified random forest component 104, and/or a computing device 102). At 1210, method 1200 can comprise generating, by the system, respective predictions from the selected one or more subtrees using the new data record (e.g., via a runtime component 210, a modified random forest component 104, and/or a computing device 102). At 1212, method 1200 can comprise performing, by the system, an ensemble operation on the generated predictions to product a final prediction result (e.g., via an ensemble component 304, a runtime component 210, a modified random forest component 104, and/or a computing device 102).

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

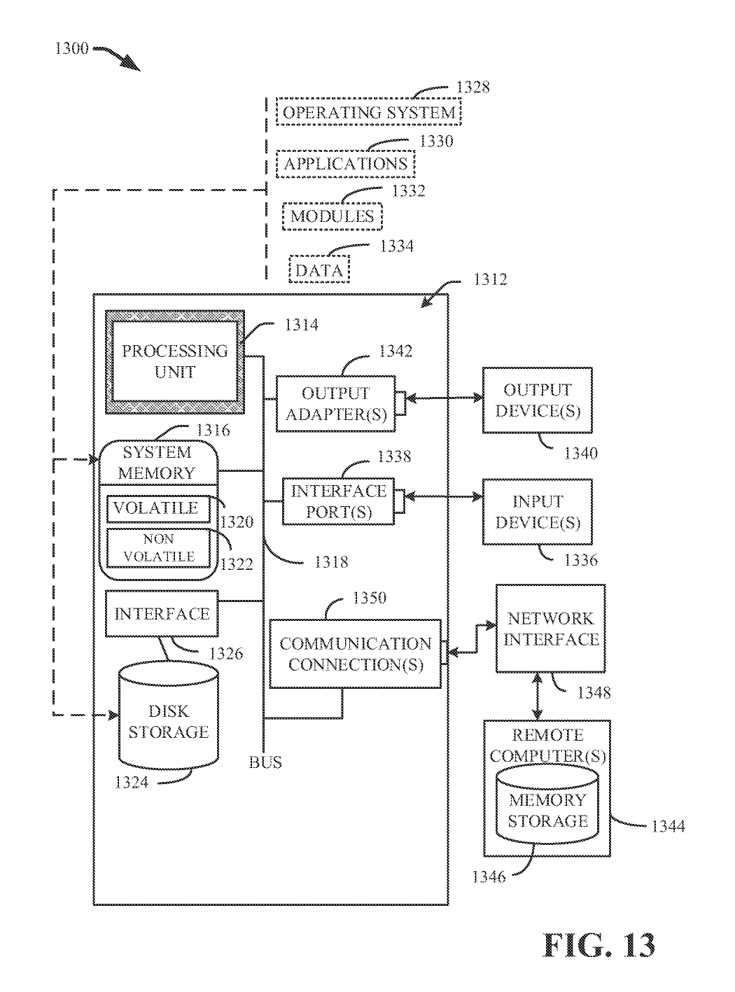

In order to provide a context for the various aspects of the disclosed subject matter, FIG. 13 as well as the following discussion are intended to provide a general description of a suitable environment in which the various aspects of the disclosed subject matter can be implemented. FIG. 13 illustrates a block diagram of an example, non-limiting operating environment in which one or more embodiments described herein can be facilitated. Repetitive description of like elements employed in other embodiments described herein is omitted for sake of brevity.

With reference to FIG. 13, a suitable operating environment 1300 for implementing various aspects of this disclosure can also include a computer 1312. The computer 1312 can also include a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314. The system bus 1318 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1494), and Small Computer Systems Interface (SCSI). The system memory 1316 can also include volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1320 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1312 can also include removable/non-removable, volatile/non-volatile computer storage media. FIG. 13 illustrates, for example, a disk storage 1324. Disk storage 1324 can also include, but is not limited to, devices like a magnetic disk drive, floppy disk drive, tape drive, Jaz drive, Zip drive, LS-100 drive, flash memory card, or memory stick. The disk storage 1324 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1324 to the system bus 1318, a removable or non-removable interface is typically used, such as interface 1326. FIG. 13 also depicts software that acts as an intermediary between users and the basic computer resources described in the suitable operating environment 1300. Such software can also include, for example, an operating system 1328. Operating system 1328, which can be stored on disk storage 1324, acts to control and allocate resources of the computer 1312. System applications 1330 take advantage of the management of resources by operating system 1328 through program modules 1332 and program data 1334, e.g., stored either in system memory 1316 or on disk storage 1324. It is to be appreciated that this disclosure can be implemented with various operating systems or combinations of operating systems. A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port can be used to provide input to computer 1312, and to output information from computer 1312 to an output device 1340. Output adapter 1342 is provided to illustrate that there are some output devices 1340 like monitors, speakers, and printers, among other output devices 1340, which require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a computer, a server, a router, a network PC, a workstation, a microprocessor based appliance, a peer device or other common network node and the like, and typically can also include many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1350 refers to the hardware/software employed to connect the network interface 1348 to the system bus 1318. While communication connection 1350 is shown for illustrative clarity inside computer 1312, it can also be external to computer 1312. The hardware/software for connection to the network interface 1348 can also include, for exemplary purposes only, internal and external technologies such as, modems including regular telephone grade modems, cable modems and DSL modems, ISDN adapters, and Ethernet cards.

In an embodiment, for example, computer 1312 can perform operations comprising: in response to receiving a query, selecting, by a system, a coarse cluster of corpus terms having a defined relatedness to the query associated with a plurality of coarse clusters of corpus terms; determining, by the system, a plurality of candidate terms from search results associated with the query; determining, by the system, at least one recommended query term based on refined clusters of the coarse cluster, the plurality of candidate terms, and the query; and communicating at least one recommended query term to a device associated with the query.

It is to further be appreciated that operations of embodiments disclosed herein can be distributed across multiple (local and/or remote) systems.

Embodiments of the present invention can be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various aspects of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a server computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems, computer program products, and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor, operably coupled to the memory, and that executes computer executable components stored in the memory, wherein the computer executable components comprise:
a significance component that:
determines whether data fields of a dataset are deemed to be significant based on a significance function,
labels a first set of the data fields that are determined to be significant with an indication of being a significant data field, and
labels a second set of the data fields that are determined not to be significant with an indication of being a non-significant data field; and
a training component that trains a modified random forest model based on a training process that employs the indication of being the significant data field and the indication of being the non-significant data field.

2. The system of claim 1, wherein the computer executable components further comprise an imputation component that imputes, during the training process, data values for ones of the second set of the data fields and that are missing data values in data records of the dataset.

3. The system of claim 2, wherein the computer executable components further comprise a sampling component that generates sample datasets from the dataset with respective sample data fields from the data fields.

4. The system of claim 3, wherein the sampling component further:
filters out, during the training process, from a sample dataset of the sample datasets, a data record having a data field from the first set and the data field is missing a data value.

5. The system of claim 4, wherein the training component further:
generates, during the training process, a subtree of the modified random forest model based on the sample dataset.

6. The system of claim 1, wherein the computer executable components further comprise a runtime component that:
imputes data values for respective data fields of the second set that are missing data values in a new data record; and
selects one or more subtrees of the modified random forest model that have sampled data fields that correspond to data fields that have data value in the new data record.

7. The system of claim 6, wherein the runtime component further:
generates predictions respectively from the one or more subtrees using the new data record; and
performs an ensemble operation on the predictions to generate a final prediction result.

8. A computer-implemented method, comprising:
determining, by a system operatively coupled to a processor, whether data fields of a dataset are deemed to be significant based on a significance function,
labeling, by the system, a first set of the data fields that are determined to be significant with an indication of being a significant data field, and
labeling, by the system, a second set of the data fields that are determined not to be significant with an indication of being a non-significant data field; and
training, by the system, trains a modified random forest model based on a training process that employs the indication of being the significant data field and the indication of being the non-significant data field.

9. The computer-implemented method of claim 8, further comprising:
imputing, by the system during the training process, data values for ones of the second set of the data fields and that are missing data values in data records of the dataset.

10. The computer-implemented method of claim 9, further comprising generating, by the system, sample datasets from the dataset with respective sample data fields from the data fields.

11. The computer-implemented method of claim 10, further comprising:
filtering out, by the system during the training process, from a sample dataset of the sample datasets, a data record having a data field from the first set and the data field is missing a data value.

12. The computer-implemented method of claim 11, further comprising:
generating, by the system during the training process, a subtree of the modified random forest model based on the sample dataset.

13. The computer-implemented method of claim 8, further comprising:
imputing, by the system, data values for respective data fields of the second set that are missing data values in a new data record; and
selecting, by the system, one or more subtrees of the modified random forest model that have sampled data fields that correspond to data fields that have data value in the new data record.

14. The computer-implemented method of claim 13, further comprising:
generating, by the system, predictions respectively from the one or more subtrees using the new data record; and
performing, by the system, an ensemble operation on the predictions to generate a final prediction result.

15. A computer program product facilitating training a modified random forest model, the computer program product comprising a computer readable storage medium having program instructions embodied therewith, the program instructions executable by a processor to cause the processer to:
determine whether data fields of a dataset are deemed to be significant based on a significance function,
label a first set of the data fields that are determined to be significant with an indication of being a significant data field, and
label a second set of the data fields that are determined not to be significant with an indication of being a non-significant data field; and
train a modified random forest model based on a training process that employs the indication of being the significant data field and the indication of being the non-significant data field.

16. The computer program product of claim 15, wherein the program instructions executable by the processor to further cause the processor to:
impute, during the training process, data values for ones of the second set of the data fields and that are missing data values in data records of the dataset.

17. The computer program product of claim 16, wherein the program instructions executable by the processor to further cause the processor to:
generate sample datasets from the dataset with respective sample data fields from the data fields.

18. The computer program product of claim 17, wherein the program instructions executable by the processor to further cause the processor to:
filter out, during the training process, from a sample dataset of the sample datasets, a data record having a data field from the first set and the data field is missing a data value.

19. The computer program product of claim 18, wherein the program instructions executable by the processor to further cause the processor to:
generate, during the training process, a subtree of the modified random forest model based on the sample dataset.

20. The computer program product of claim 15, wherein the program instructions executable by the processor to further cause the processor to:
impute data values for respective data fields of the second set that are missing data values in a new data record;
selecting, by the system, one or more subtrees of the modified random forest model that have sampled data fields that correspond to data fields that have data value in the new data record; and
generate predictions respectively from the one or more subtrees using the new data record.
